(19) United States
(12) Patent Application Publication
(10) Pub. No.: US 2008/0264293 A1
(43) Pub. Date: Oct. 30, 2008

(54) Method of Improving the Adhesion of Cement-Bound Coatings to Concrete Surfaces

(75) Inventors: Thomas Staffel, Grunstadt (DE); Siegbert Weber, Ladenburg (DE)

Correspondence Address: FOLEY AND LARDNER LLP;SUITE 500, 3000 K STREET NW, WASHINGTON, DC, 20007, US

(73) Assignee: BK GIULINI GMBH, Ludwigshafen (DE)

(21) Appl. No.: 12/092,473

(22) PCT Filed: Oct. 28, 2006
(86) PCT No.: PCT/EP06/10386

§ 371 Date: Jun. 27, 2008

(30) Foreign Application Priority Data
Nov. 5, 2005 (DE) 10 2005 052 791.4

(51) Int. Cl. C04B 28/02; C09D 5/16

(52) U.S. Cl. 106/18.31; 106/638; 106/286.8; 106/286.7

(57) ABSTRACT

The present invention relates to plastering mortars which exhibit enhanced adhesion to concrete surfaces and comprise monofluorophosphates, to adhesion primers comprising monofluorophosphates, and to a method of improving the adhesion of cement-bound plasters to concrete surfaces, which involves applying a monofluorophosphate to the concrete surface.

The present invention relates to plastering mortars with an improved adhesion to concrete surfaces, adhesion primers and to the use of monofluorophosphates for enhancing the adhesion of cement-bound plasters to concrete surfaces.

For numerous reasons, structural parts with concrete surfaces are experiencing increasingly wide application. On the one hand, buildings are being constructed of concrete, on the other hand, prefabricated structural units such as walls, intermediate floors etc. of concrete are widely used. In both cases, further finishing of the surfaces is normally required on erection of the shell. For this purpose, plaster is predominantly applied onto the surfaces as the first step, which is then provided with paint, wallpapers, facing plaster or other wall coatings. In the case of particularly level concrete surfaces, it is possible to apply a facing plaster directly.

Basically, plasters can be subdivided into cement-bound plasters and gypsum plasters. Especially on surfaces made of concrete gypsum plasters result in serious problems, since gypsum and concrete react differently on drying and/or to changing temperatures. When applying gypsum plaster on relatively fresh concrete, in particular, flaking off of the gypsum plaster has to be expected since concrete shrinks on drying, whereas gypsum does not. For this reason, cement-bound plastering mortars are recommended in particular for fresh concrete surfaces.

However, even cement-bound plastering mortars, too, do not always adhere satisfactorily to concrete surfaces, in particular in the case of pre-fabricated concrete units.

It has therefore been suggested to use plate dowels for improved bonding of the plaster to the concrete surface.

Adhesion primers, too, are widely used. Adhesion primers contain predominantly quartz sand in a binder based on synthetic resin. These adhesion primers are applied onto the concrete surface thus creating a rough surface on which the plaster is able to adhere better.

However, adhesion primers based on synthetic resins require a certain minimum processing temperature and a fairly long drying time for a stable weight-bearing surface to be actually formed.

Consequently, there continues to be a requirement for a simple and secure solution for producing adhesion of plastering mortar on concrete surfaces. The object of the present invention consequently consisted of providing a plastering mortar and/or an adhesion primer which provide a secure adhesion on concrete surfaces.

Surprisingly it has now been found that the object is solved by using monofluorophosphates as additive to plaster, concrete and/or adhesion primers.

In one embodiment, the present invention consequently provides a plastering mortar which contains a monofluorophosphate. In a further embodiment, an adhesion primer is provided containing a monofluorophosphate.

Plastering mortar should be understood within the scope of the present invention to be mixtures which contain at least one hydraulically setting binder and one aggregate.

Suitable hydraulically setting binders are cement, lime, mixtures thereof and gypsum. Cement-bound plastering mortars in the case of which cement, e.g. Portland cement, metallurgical cement, Portland trass cement etc form the hydraulic binder, and lime cement plasters are particularly preferred.

Sand usually serves as aggregate. Typically, sand has a predominant grain fraction of between 0.25 and 4 mm, depending on the type of plaster. In fine rendering, the largest grain is typically between 0.5 and 1 mm, in plasters for thicker coats also 8 to 10 mm in size. Other materials such as synthetic resin granules, expanded minerals etc. may, depending on the type of plaster, be alternatively or additionally contained therein as aggregate, e.g. in light-weight external rendering or face plaster.

In addition, the plastering mortar may contain additives and admixtures known as such, such as e.g. air entraining agents, setting accelerators, setting retarders and colouring agents.

As a rule, plastering mortar is a dry mixture which has to be mixed with water.

The monofluorophosphates used according to the invention for enhancing adhesion and their production are known as such. Monofluorophosphates and, in particular, sodium monofluorophosphate have previously been used, among other things, as wood preservative (U.S. Pat. No. 4,824,484), as anti-corrosion agent (U.S. Pat. No. 4,608,092; U.S. Pat. No. 4,613,450 and U.S. Pat. No. 5,071,579) and for reducing the flaking off of concrete (DE 692 05 968). Their use as accelerator for concrete is also known.

According to the invention, monofluorophosphates, preferably alkali monofluorophosphates and alkaline earth monofluorophosphates and in particular sodium monofluorophosphate, potassium monofluorophosphate, magnesium monofluorophosphate and/or calcium monofluorophosphate are suitable. Especially preferred are sodium monofluorophosphate and/or potassium monofluorophosphate.

According to a preferred embodiment, the monofluorophosphate is added to the plaster mortar in a quantity of 0.05 to 5% by weight, preferably 0.05 to 1% by weight and in particular 0.1 to 0.5% by weight, based on the binder of the plaster mortar. A particular advantage of this embodiment consists of the fact that no pre-treatment or other additional steps are necessary at the construction site, it being possible for metering to take place accurately and precisely as early as during the manufacture of the plaster mortar in the factory.

In a further preferred embodiment, a preferably aqueous solution with a proportion of monofluorophosphate of 1 to 30% by weight, preferably 5 to 30% by weight and in particular 10 to 25% by weight is used as adhesion primer. The upper limit results in this case from the solubility of the monofluorophosphate, the adhesion primer having to be a stable solution which should not exhibit any precipitation of monofluorophosphate even when cooled to e.g. 5° C. Naturally, an application of monofluorophosphate in quantities of more than necessary should be avoided also for reasons of costs. The lower limit results from the quantity to be applied in each case. This may be determined by the expert depending on the method of application in such a way that the required quantity of monofluorophosphate can be applied in a single or double application.

The application of the adhesion primer according to the invention should be effected in quantities of 1 to 100 g/m², preferably 10 to 80 g/m² and in particular 20 to 50 g/m².

The adhesion primer according to the invention may be applied in a manner known as such, e.g. by brush application, roller application, spray application or dipping.

The application can be effected in one or several steps, drying preferably taking place between individual applications in the case of two or repeated applications.

The advantage in comparison with conventional adhesion primers consists of the fact that, after drying, plastering can begin immediately. A waiting period as required for setting the binders based on synthetic resin of the known adhesion primers can be omitted. A further advantage of this embodiment consists of the fact that the use of the monofluorophosphate takes place in a targeted manner only at the site where it is required, namely at the boundary surface between concrete and plaster.

Moreover, the adhesion primer according to the invention can be provided with further constituents such as e.g. fungicides, dyes etc. such that additional effects can be achieved by the application.

Insofar as further constituents are contained therein, these are present in the usual quantities provided for the constituent concerned.

The following examples are to illustrate the invention in further detail without limiting it, however, to the specific embodiments. Unless indicated otherwise, all %-indications relate to the weight.

### EXAMPLE 1

Commercial bricklayer's mortar was mixed with water according to the specifications and then panels with the dimensions of 25 cm×24 cm and a thickness of approximately 2.5 cm were cast to make a concrete surface. The panels were provided with a commercial plinth plaster and then optically assessed before and after 2.5 months weathering in the open air. The plinth plaster was also mixed with water according to the specifications and then a quantity of approximately 950 g was evenly applied onto the panels by means of a trowel.

For panels 1 and 2, approximately 1.5 g of sodium monofluorophosphate or potassium monofluorophosphate were mixed with 1600 g of plinth plaster and 300 g of water, corresponding to approximately 0.3% monofluorophosphate, based on the binder.

For panels 3 and 4, approximately 1.5 g of sodium monofluorophosphate or potassium monofluorophosphate were dissolved in 28.5 g of water and the solution was distributed on the panel by means of a brush. After 1 h, the panel was dry and the plaster application was started.

Panel 5 was produced as a comparison without monofluorophosphate.

In a further series of tests, steel reinforcements were incorporated into the panels in such a way that part of the steel protruded from the surface in order to examine the influence of exposed steel reinforcements. Again, 5 panels were produced, panels 6 and 7 analogous to panels 1 and 2, panels 8 and 9 analogous to panels 3 and 4 and panel 10 analogous to panel 5.

The results are summarised in table 1.

TABLE 1

| | | Brush- | | |
|---|---|---|---|---|
| | Monofluoro- | coated | | |
| | phosphate | with | | Assessment |
| | in the | monofluoro- | Assessment | after |
| Panel | mortar | phosphate | after one day | weathering |
| 1 | Yes, Na | ./. | Smooth surface | No change |
| 2 | Yes, K | ./. | Smooth surface | No change |
| 3 | ./. | Yes, Na | Smooth surface | No change |
| 4 | ./. | Yes, K | Fine cracks | No change |
| 5 | ./. | ./. | Fine cracks | The plaster |
| | | | | has become |
| | | | | loose in |
| | | | | places, can |
| | | | | be lifted off |
| 6 | Yes, Na | ./. | Smooth surface | No change |
| 7 | Yes, K | ./. | Smooth surface | No change |
| 8 | ./. | Yes, Na | Smooth surface | No change |
| 9 | ./. | Yes, K | Smooth surface | No change |
| 10 | ./. | ./. | Smooth surface | The plaster |
| | | | | has become |
| | | | | loose in |
| | | | | places, can |
| | | | | be lifted off |

Even during this simple test, it becomes apparent that sodium monofluorophosphate and potassium monofluorophosphate lead to a substantial improvement of adhesion when used either as an admixture to the plaster mortar or as pre-treatment of the concrete surface. The formation of cracks is avoided, adhesion is considerably enhanced. This applies irrespective of whether or not reinforcement steel protrudes from the concrete surface.

### EXAMPLE 2

Specimen panels with the dimensions of 35 cm×25 cm×5 cm were produced from standardised concrete, removed from the moulds after one day and then stored for one week in water and for three weeks in a standard climate.

A lime cement bonding finish coat CS III in line with DIN EN 998/1 (KHF™, Schwenk Putztechnik GmbH & Co. KG, DE) is mixed, if applicable with sodium monofluorophosphate, mixed with water according to the specifications and applied in a thickness of 0.7 cm using a trowel onto the specimen panels which, if applicable have been brush coated with an aqueous solution of sodium monofluorophosphate.

The bond is assessed visually by assessing scanning electron micrographs (SEM) of the boundary layers.

For the SEM micrographs, the sample panels were sawn into strips approximately 10 mm thick using a rock saw. These strips were dried at 40° C. until the equilibrium moisture content was reached and divided by means of a rock press such that the bond between the concrete and the plaster became visible at the fracture surface. The samples were then bonded onto sample holders using “carbon cement” according to Glöcke and the surface was made electrically conductive by sputtering with gold. For this purpose, a sputter coater of type SCD 005 from BAL-TEC was used, the operating distance was 50 mm, the vacuum 5×10⁻² mbar in an argon atmosphere, the sputter current 60 mA, the time 60 s.

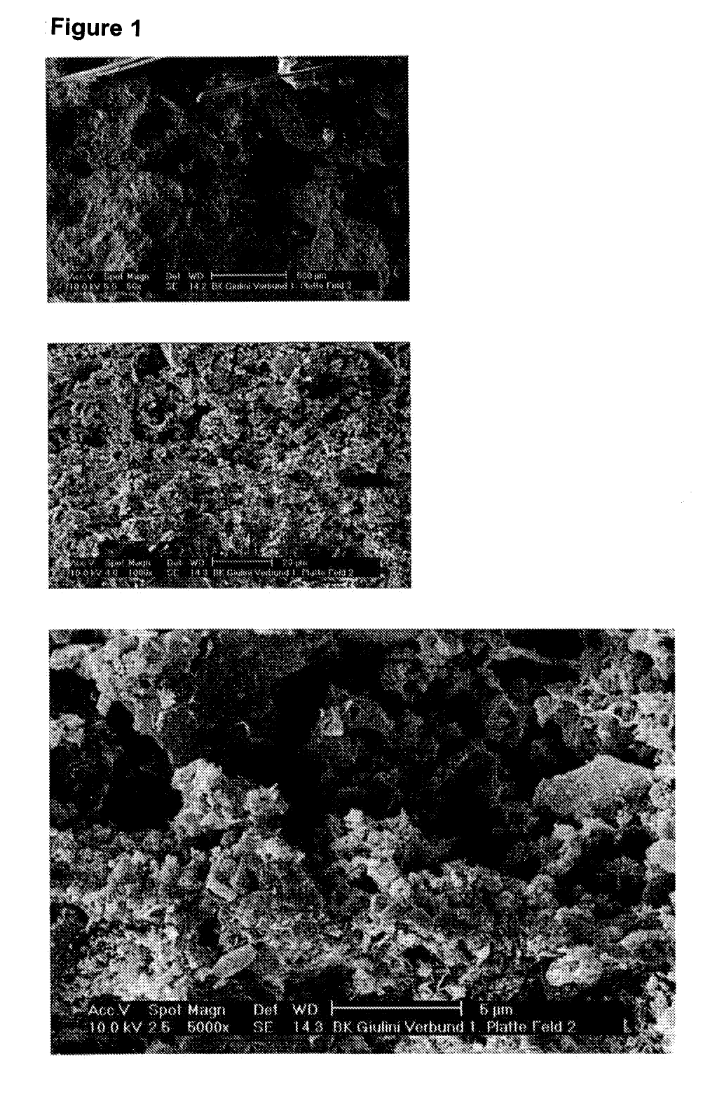

The results are illustrated in FIGS. 1 to 4. Three magnification stages are represented respectively.

FIG. 1 shows the bond between a plaster with 0.1% sodium monofluorophosphate (based on the binder) and the concrete surface. It can be seen that a porous layer of calc-sinter is formed by the monofluorophosphate between the concrete and plaster, positively influencing adhesion.

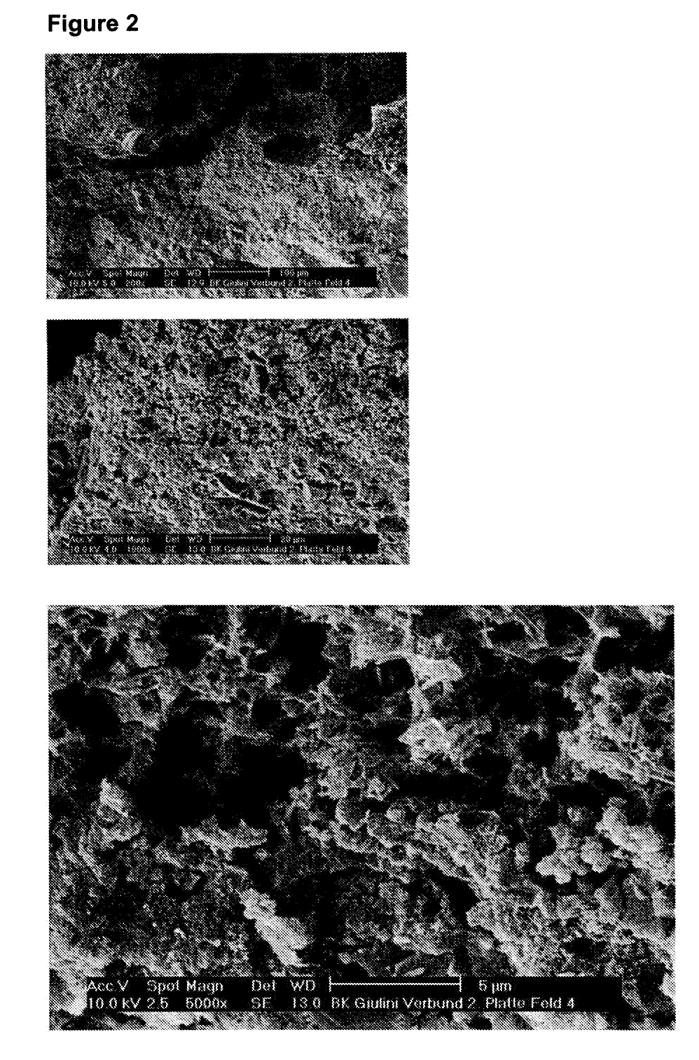

In FIG. 2, the bond between a non-modified plaster and a concrete surface treated 1× with sodium monofluorophosphate, application quantity 18.5 g/m², is illustrated. The hydration of the plaster in the bonding zone is improved, the calc-sinter layer on the concrete surface is thin and porous.

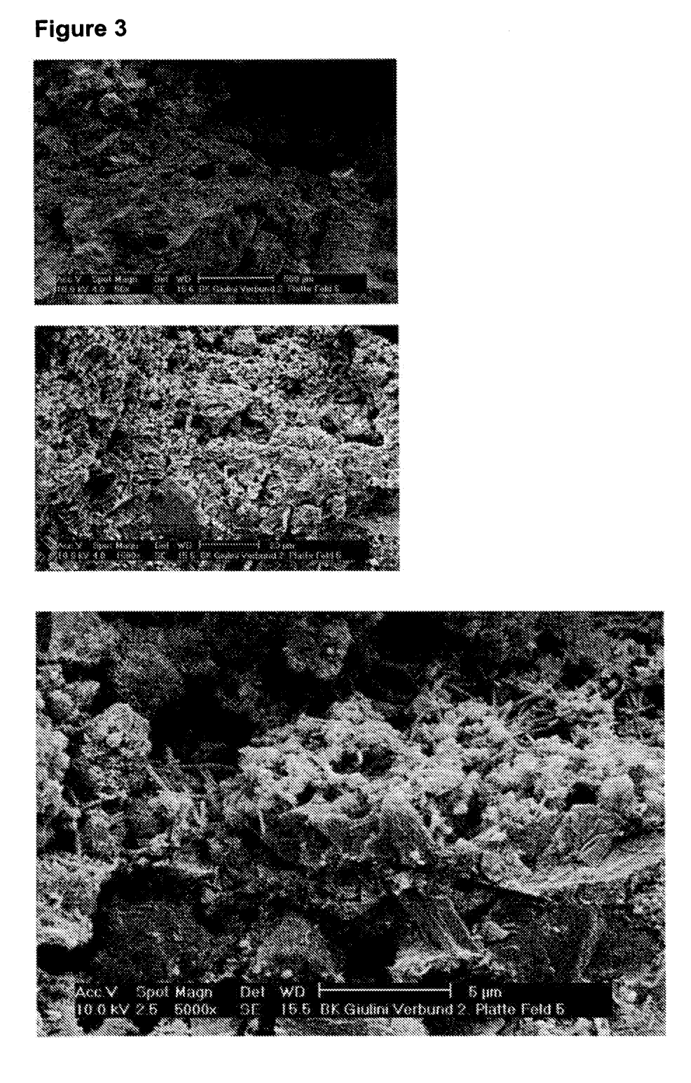

FIG. 3 shows the bond between a non-modified plaster and a concrete surface treated 2× with sodium monofluorophosphate, total application quantity 34.5 g/m². In comparison with FIG. 2, the hydration of the plaster has been further improved, further compaction has been achieved. The inter-growth of plaster and concrete progressed to such an extent, that a site had to be sought for the SEM micrography where the transition is still visible.

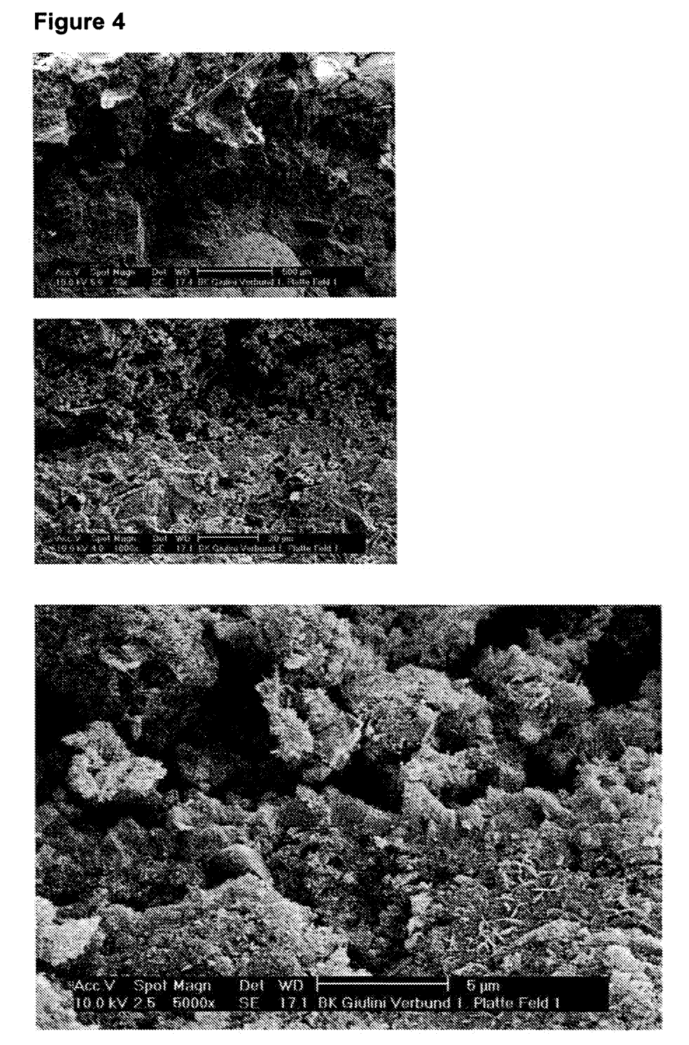

In FIG. 4, the bond between a non-modified plaster and an untreated concrete surface is shown for comparison. It can be seen that a sharp boundary is present, the cement stone of the concrete is highly compact as is the hardly recognisable calca-sinter layer.

As a result it can be observed that both the admixture of monofluorophosphate to the plaster mortar and the use as adhesion primer lead to the formation of a porous calca-sinter layer which markedly improves the adhesion of the plaster to the concrete surface.

### EXAMPLE 3

Analogous to example 2, specimen panels were produced and coated with plaster. The adhesion was determined by means of adhesion tensile tests.

For this purpose, the specimen panels were stored for 14 or 28 days in plastic film. Analogous to example 2, 0.1% sodium monofluorophosphate was incorporated into the plaster and/or 18.5 or 34.5 g/m² of sodium monofluorophosphate were applied onto the surface by single or double treatment.

To determine the adhesion tensile strengths, round specimens were sawn from the panels after 14 and 28 days. Using an adhesion tensile test device Easy M (Freundl, Del.) the adhesion tensile strength was measured.

The results which represent mean values from two specimens in each case are summarised in Table 2.

TABLE 2

| | | Brush | Adhesion | Adhesion |
|---|---|---|---|---|
| | Monofluoro- | coated with | tensile | tensile |
| | phosphate | monofluoro- | strength after | strength |
| Panel | in mortar | phosphate | 14 days | after 28 days |
| 1 | 0.1% | ./. | 0.65 N/mm² | 0.60 N/mm² |
| 2 | ./. | 1x | 0.57 N/mm² | 0.45 N/mm² |
| 3 | ./. | 2x | 0.60 N/mm² | 0.40 N/mm² |
| 4 | ./. | ./. | 0.25 N/mm² | 0.15 N/mm² |

Although the range of variations of the measured values was relatively high, it can be seen that a significant improvement of adhesion is obtained both by an addition to the plaster and by treating the concrete surface.

1.-13. (canceled)

14. Plaster mortar comprising a hydraulic binder and an aggregate wherein at least one monofluorophosphate is contained therein.

15. Plaster mortar according to claim 14, wherein one or several alkali monofluorophosphate(s), preferably sodium monofluorophosphate and/or potassium monofluorophosphate is/are contained therein.

16. Plaster mortar according to claim 14, wherein 0.05 to 5% by weight, preferably 0.05 to 1% by weight and in particular 0.1 to 0.5% by weight of monofluorophosphate, based on the binder of the plaster mortar, are contained therein.

17. Adhesion primer for concrete surfaces containing at least one monofluorophosphate in aqueous solution.

18. Adhesion primer according to claim 17, wherein monofluorophosphate is contained therein in a proportion of 1 to 30% by weight, preferably 5 to 30% by weight and in particular 10 to 25% by weight.

19. Adhesion primer according to claim 17, wherein one or several alkali monofluorophosphate(s), preferably sodium monofluorophosphate and/or potassium monofluorophosphate is/are contained therein.

20. Adhesion primer according to claim 17, wherein one or several further constituents such as fungicides, dyes etc. is/are contained therein.

21. Process for improving the adhesion of plaster on concrete surfaces wherein at least one monofluorophosphate is applied onto the concrete surface.

22. Process according to claim 21, wherein 1 to 100 g/m2, preferably 10 to 80 g/m2 and in particular 20 to 50 g/m2 of monofluorophosphate are applied onto the concrete surface.

23. Process according to claim 22, wherein one or several alkali monofluorophosphate(s), preferably sodium monofluorophosphate and/or potassium monofluorophosphate is/are applied onto the concrete surface.

24. Adhesion primer according to claim 18, wherein one or several alkali monofluorophosphate(s), preferably sodium monofluorophosphate and/or potassium monofluorophosphate is/are contained therein.
